(19) United States
(12) Patent Application Publication
(10) Pub. No.: US 2026/0329916 A1
(43) Pub. Date: Oct. 22, 2026

(54) AUTOMATED DECISION MAKING FOR MULTIPLE DATASETS WITH MACHINE LEARNING

(71) Applicant: NEC Laboratories America, Inc., Princeton, NJ (US)

(72) Inventors: Iain Melvin, Princeton, NJ (US); Christopher Malon, Fort Lee, NJ (US); Renqiang Min, Princeton, NJ (US)

(21) Appl. No.: 19/466,967

(22) Filed: Feb. 2, 2026

Related U.S. Application Data
(60) Provisional application No. 63/754,634, filed on Feb. 6, 2025.

(51) Int. Cl. G06F 16/338; B60W 60/00; G06F 16/3329

(52) U.S. Cl. CPC G06F 16/338; B60W 60/0015; G06F 16/33295

(57) ABSTRACT

Systems and methods for automated decision making for multiple datasets with machine learning. A decision making entity can be prompted with an interface to generate user queries for entity documents from multiple entities. A query answer can be generated for the entity documents with an iterative question answer controller. The query answer can be converted into a dimensional matrix. Semantic data regarding the query answer can be visualized from the dimensional matrix with a visualization component of the iterative question answer controller to perform downstream tasks to resolve issues with the multiple entities.

### RELATED APPLICATION INFORMATION

This application claims priority to U.S. Provisional App. No. 63/754,634, filed on Feb. 6, 2025, incorporated herein by reference in its entirety.

### BACKGROUND

### Technical Field

The present invention relates to automated decision making with artificial intelligence (AI), and more particularly automated decision making for multiple datasets with machine learning.

### Description of the Related Art

AI models have been progressing in a rapid state due to their popularity. AI models have been used for image processing and text processing. However, AI models can be specialized for the modality that is trained on which can result in inaccurate predictions for other modalities, which make them unreliable for generating insights.

### SUMMARY

According to an aspect of the present invention, a method is provided, including, prompting a decision making entity with an interface to generate user queries for entity documents from multiple entities, generating a query answer for the entity documents with an iterative question answer controller, converting the query answer into a dimensional matrix, and visualizing semantic data regarding the query answer from the dimensional matrix with a visualization component of the iterative question answer controller to perform downstream tasks to resolve issues with the multiple entities.

According to another aspect of the present invention, a system is provided, including, a memory device, one or more processor devices operatively coupled with the memory device to perform operations including, prompting a decision making entity with an interface to generate user queries for entity documents from multiple entities, generating a query answer for the entity documents with an iterative question answer controller, converting the query answer into a dimensional matrix, and visualizing semantic data regarding the query answer from the dimensional matrix with a visualization component of the iterative question answer controller to perform downstream tasks to resolve issues with the multiple entities.

According to yet another aspect of the present invention, a non-transitory computer program product is provided including a computer-readable storage medium including a program code, wherein the program code when executed on a computer causes the computer to perform operations including, prompting a decision making entity with an interface to generate user queries for entity documents from multiple entities, generating a query answer for the entity documents with an iterative question answer controller, converting the query answer into a dimensional matrix, and visualizing semantic data regarding the query answer from the dimensional matrix with a visualization component of the iterative question answer controller to perform downstream tasks to resolve issues with the multiple entities.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a computer system for automated decision making for multiple datasets with machine learning, in accordance with an embodiment of the present invention;

FIG. 2 is a block diagram that shows a computer system for automated decision making for multiple datasets with machine learning, in accordance with an embodiment of the present invention;

FIG. 3 is a block diagram that shows hardware and software components of a computer system for automated decision making for multiple datasets with machine learning, in accordance with an embodiment of the present invention;

FIG. 4 is a block diagram that shows components of an iterative question answer controller for automated decision making for multiple datasets with machine learning, in accordance with an embodiment of the present invention;

FIG. 5 is a flow diagram that shows a high-level overview of a method for automated decision making for multiple datasets with machine learning, in accordance with an embodiment of the present invention; and

FIG. 6 is a block diagram that shows elements of a visualization component of a computer system for automated decision making for multiple datasets with machine learning, in accordance with an embodiment of the present invention.

### DETAILED DESCRIPTION OF PREFERRED EMBODIMENTS

In accordance with embodiments of the present invention, systems and methods are provided for automated decision making for multiple datasets with machine learning.

In an embodiment, a decision making entity can be prompted with an interface to generate user queries for entity documents from multiple entities. A query answer can be generated for the entity documents with an iterative question answer controller. The query answer can be converted into a dimensional matrix. Semantic data regarding the query answer can be visualized from the dimensional matrix with a visualization component of the iterative question answer controller to perform downstream tasks to resolve issues with the multiple entities.

When making decisions about a large set of entities (e.g., companies, system components, traffic scene/autonomous vehicle, etc.), an analyst is often faced with a very large number of documents to read and process. The documents contain information about entities companies. Often the analyst will base their decision on summaries and not access all the relevant details in each document.

LLM (Large Language Models) and RAG (Retrieval Augmented Generation) techniques permit questioning and answering over documents in a conversational style. But asking lots of questions over lots of documents from different entities (e.g., companies) can result in an even larger amount of unstructured information in the answers for the analyst to manage. Questions can be posed in any Language the LLM can understand. Requested answers can be present in the data and are extracted, or can be estimated by the LLM given the available data. Questions can be very high level, for example: “Does this company have a Green policy?”.

As such, there is a need to present the outputs from these models in a format that is easy for the end user to process. Additionally, there is a need for an application that is simple, intuitive to use, and able to demonstrate the ability for the user to discover structure in the data such as discovering clusters or trends between companies.

To resolve these issues, the present embodiments can utilize multiple Large Language Models over multiple documents to give query answers to the user queries for each entity in an iterative manner. The present embodiments can utilize specialist models for different modalities. The present embodiments can utilize a multi agent approach to generate one response over a set of specialist models and a set of documents.

The present embodiments can generate Boolean and Numeric responses using the LLMs, which can be used as dimensions to explore. This set of responses then forms a 2-dimensional matrix [ “Number Of Questions” x ”Number Of entities” ] which the present embodiments can use to describe the set.

The present embodiments can then visualize the results in a user application. The present embodiments enable the user to select different dimensions (answers) for embedding or assigning to display axes. The present embodiments enable the user to select a subset of the data by “lasso” or a “threshold” selection and filter the data to a reduced set. The filtering process is recorded and can be navigate (like a browser history).

The present embodiments automatically ask the users questions over the whole set of entities and documents and store the results. This avoids excessive manual labor and interaction with the user.

The answers create new “dimensions” for visualization by dimensionality reduction techniques and show the companies in an interactive display. The present embodiments can utilize uniform manifold approximation and projection (UMAP) or t-distributed stochastic neighbor embedding (tSNE) to embed high dimensional data to 2 dimensions for visualization. The high dimensions can correspond to the number of questions the user is currently interested in, and has selected in the user interface. Such an embedding can reveal clusters of interest to the analyst. For numeric answers, this also enables direct plotting of the answers on an axis directly (for example, plotting Company Profits for 2022 or Weight of Animal in Pounds). Any combination of axes can be selected at visualization time.

The present embodiments eliminate the need for users to directly process the data, as data preprocessing is eliminated. Additionally, the present embodiments reduce the computational resources (e.g., processing, memory, system complexity) of processing multiple documents from multiple entities. Moreover, the present embodiments allow navigation and/or selection of the data along novel dimensions, or combination of those dimensions.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

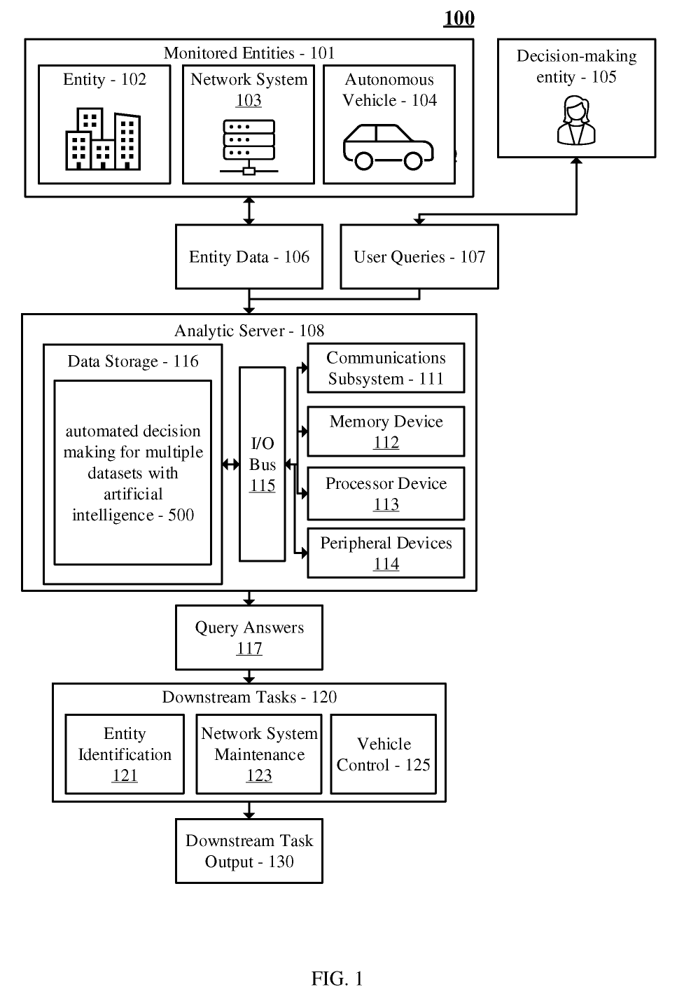

Referring now in detail to the figures in which like numerals represent the same or similar elements and initially to FIG. 1, a block diagram shows a computer system for automated decision making for multiple datasets with machine learning, in accordance with an embodiment of the present invention.

In an embodiment using a system 100, monitored entities 101 can include entity 102, network system 103, and autonomous vehicle 104. The monitored entities 101 can generate entity data 106 which can include image/video, text, etc. User queries 107 can be obtained from decision making entity 105 and can be transmitted to an analytic server 108 that can implement automated decision making for multiple datasets with machine learning 500. The analytic server 108 can obtain query answers 117 which can be utilized to perform downstream tasks 120.

System 100 can be utilized to perform downstream tasks 120 based on the entity data 106 and user queries 107 from a decision-making entity 127. The downstream tasks 120 can include entity identification 121, system maintenance 123, and vehicle control 125. The analytic server 108 can generate features useful for the downstream tasks (e.g., decision making tasks) such as a corrective action for the downstream tasks 120 to be sent to respective computing systems for the monitored entities 101 through a network.

In entity identification 121, the image/video or text (e.g., location images, scene images, entity images such as parts of the entity, etc.) related to the entity 102 can be processed by the analytic server 108 to answer user queries 107 based on the query answers 117 by the analytic server 108. The user queries 107 can be relevant to the entity 102 such as their attributes (e.g., position, direction of movement, trends of decisions, etc.), relationship with other entities within an environment (e.g., proximity, behavior, etc.), relationship with the environment, etc. The analytic server 108 can predict future attributes, and relationships of the entity 102. In another embodiment, the entity 102 can be a patient within a monitored environment with a monitored equipment. The analytic server 108 can monitor the status of entity 102 and provide answers related to the healthcare data of the patient. Based on the status, parameters of the monitored equipment used for the patient can be updated through automated decision making.

Based on the outputs of the analytic server 108, features for a corrective action for the downstream tasks 120 can be generated. The corrective action can include notifying the decision making entity 105 of the predictions about the entity 102 based on their entity data 106, generating resolutions to an issue caused by the entity (e.g., the entity 102 as a disabled vehicle in a traffic scene and the resolution is the deployment of a repair technician, offloading products from a monitored entity, etc.) of the image/video to help with the decision making process of the decision making entity 105, etc.

In system maintenance 123, entity data 106 including image/video or text description (e.g., system logs, test cases, hardware status images, etc.) related to the network system 103 can be processed to answer user queries 107 for the network system 103 generated by the analytic server 108. The user queries 107 can be relevant on how to properly maintain the network system 103, or whether the system component is properly functioning based on the entity data 106. Features for a corrective action for downstream tasks 120 can be generated by the analytic server 108 which can include the answer to the user queries 107 (e.g., determine causes to bandwidth issues, etc.) to maintain the network system 103. Based on the features, (e.g., adding bandwidth, blocking packets from an identified internet protocol (IP) address to resolve malicious attacks, restarting hardware, redirecting processing of component, etc.) the network system can be autonomously maintained.

In vehicle control 125, entity data 106 (e.g., vehicle part status, traffic scene image, trajectories, etc.) related to the autonomous vehicle 104 can be processed to answer user queries 107. The user queries 107 can be relevant to how to control the autonomous vehicle 104 given its environment based on the entity data 106. Features for a corrective action for downstream tasks 120 can be generated by the analytic server 108 which can include the answer to the user queries 107 to control the proper performance of the autonomous vehicle 104. Based on the corrective action (e.g., stopping, speeding up, changing direction, etc.) the autonomous vehicle 104 can be autonomously controlled using appropriate control devices (e.g., advanced driver assistance systems, braking device, accelerator device, cooling device, etc.) within the autonomous vehicle 104. In an embodiment, the autonomous vehicle 104 can be controlled in response to avoid a predicted event based on a generated trajectory based on the query answers 117 generated by the analytic server 108 such as multi-vehicle collision, accidents, detected road hazards, etc.

Other downstream tasks and practical applications are contemplated.

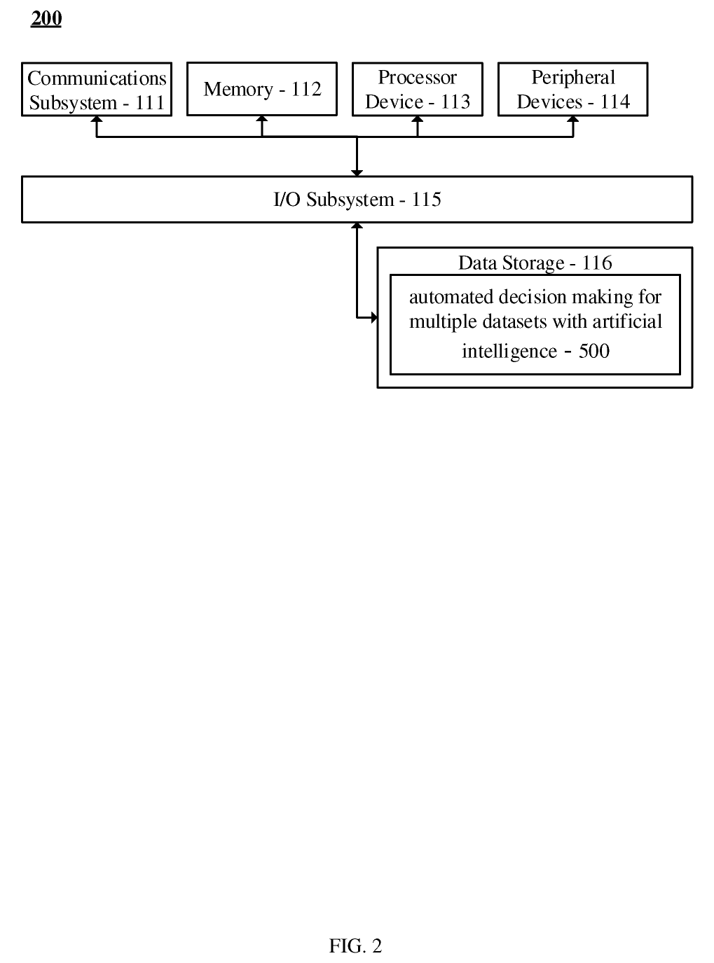

The analytic server 108 can include a processor device 113, data storage device 116, memory 112, communications subsystem 111, peripheral devices 114, and input/output (I/O) bus 115. The analytic server 108 is an implementation of a computer system. Other implementations are contemplated. The computer system is shown in more detail in FIG. 2.

Referring now to FIG. 2, a block diagram shows a computer system for automated decision making for multiple datasets with machine learning, in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 can include other or additional components, such as those commonly found in a server computer (e.g., various input/output devices), in other embodiments. Additionally, in some embodiments, one or more of the illustrative components can be incorporated in, or otherwise form a portion of, another component. For example, the memory 112, or portions thereof, can be incorporated in the processor device 113 in some embodiments.

The processor device 113 can be embodied as any type of processor capable of performing the functions described herein. The processor device 113 can be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 can be embodied as any type of volatile or non-volatile memory or data storage capable of performing the functions described herein. In operation, the memory 112 can store various data and software employed during operation of the computing device 200, such as operating systems, applications, programs, libraries, and drivers. The memory 112 is communicatively coupled to the processor device 113 via the I/O subsystem 115, which can be embodied as circuitry and/or components to facilitate input/output operations with the processor device 113, the memory 112, and other components of the computing device 200. For example, the I/O subsystem 115 can be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 can form a portion of a system-on-a-chip (SOC) and be incorporated, along with the processor device 113, the memory 112, and other components of the computing device 200, on a single integrated circuit chip.

The data storage device 116 can be embodied as any type of device or devices configured for short-term or long-term storage of data such as, for example, memory devices and circuits, memory cards, hard disk drives, solid state drives, or other data storage devices. The data storage device 116 can store program code for automated decision making for multiple datasets with machine learning 500. Any or all of these program code blocks can be included in a given computing system.

The communications subsystem 111 of the computing device 200 can be embodied as any network interface controller or other communication circuit, device, or collection thereof, capable of enabling communications between the computing device 200 and other remote devices over a network. The communications subsystem 111 can be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 can also include one or more peripheral devices 114. The peripheral devices 114 can include any number of additional input/output devices, interface devices, and/or other peripheral devices. For example, in some embodiments, the peripheral devices 114 can include a display, touch screen, graphics circuitry, keyboard, mouse, speaker system, microphone, network interface, and/or other input/output devices, interface devices, GPS, camera, and/or other peripheral devices.

Of course, the computing device 200 can also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

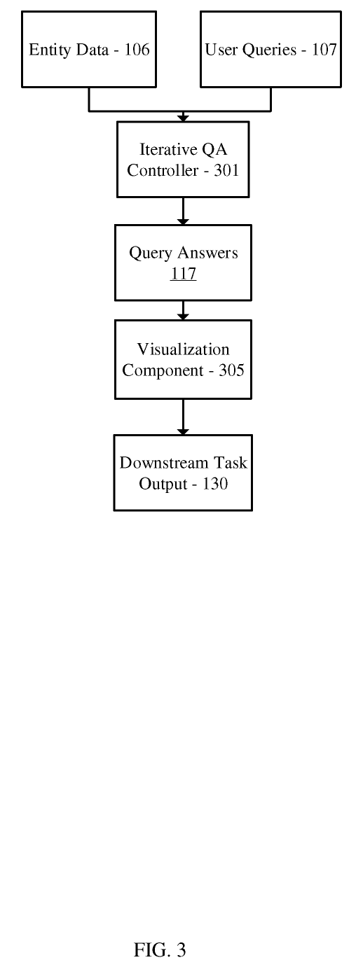

Referring now to FIG. 3, a block diagram shows hardware and software components of a computer system for automated decision making for multiple datasets with machine learning, in accordance with an embodiment of the present invention.

In an embodiment, entity data 106 and user queries 107 can be processed by an iterative question answer (QA) controller 301 to generate query answers 117. The query answers 117 can be visualized in multiple dimensions by using a visualization component 305 to display semantic information regarding the query answers 117 based on the user queries 107. A downstream task output 130 can be generated based on the semantic information.

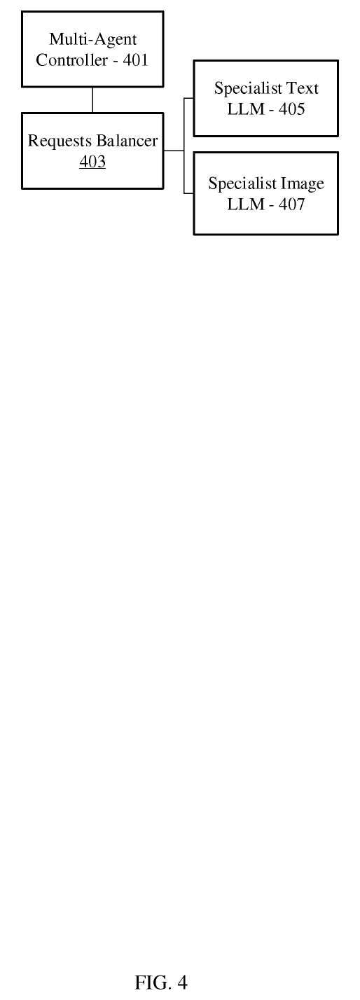

Referring now to FIG. 4, a block diagram shows components of an iterative question answer controller for automated decision making for multiple datasets with machine learning, in accordance with an embodiment of the present invention.

In an embodiment, the iterative QA controller 301 can utilize a multi-agent controller (MAC) 401, a requests balancer 403, a specialist text large language model (LLM) 405 and a specialist image LLM 407.

The multi-agent controller 401 can generate a single answer for the entity data 106 and the user queries 107. The requests balancer 403 processes requests from the multi-agent controller 401 and converts high-level labels from the requests into Internet Host address for a machine learning model service. The machine learning model service can include a specialist text LLM 405 and a specialist image LLM 407. The specialist text LLM 405 can process text and generate inference based on the text inputs. The specialist image LLM 407 can process images and generate inference based on the text images. Other types of machine learning model service can be utilized.

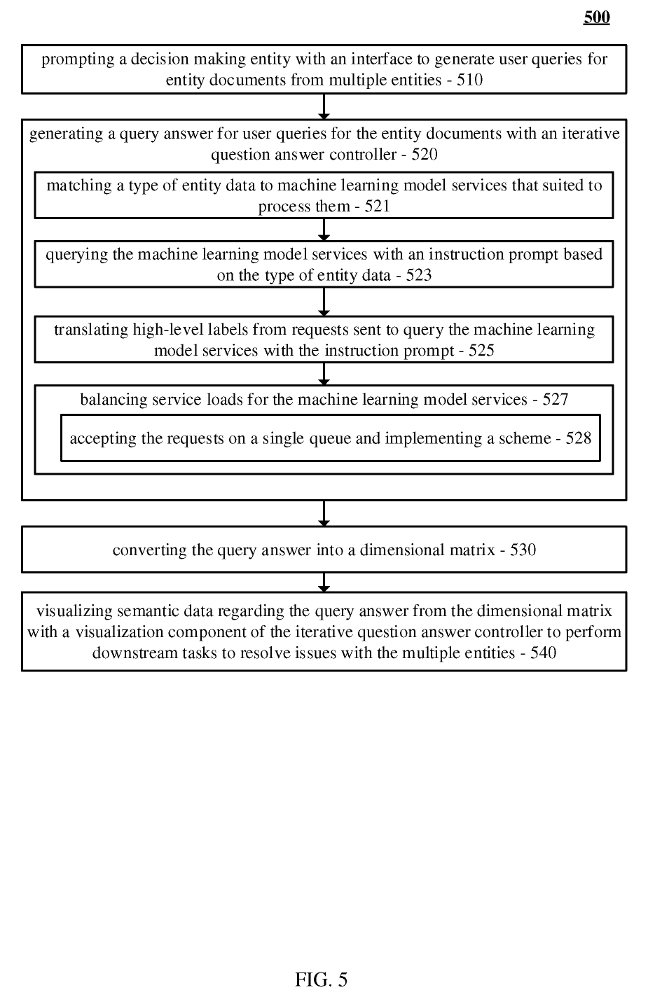

Referring now to FIG. 5, a flow diagram shows a high-level overview of a method for automated decision making for multiple datasets with machine learning, in accordance with an embodiment of the present invention.

In an embodiment, a decision making entity can be prompted with an interface to generate user queries for entity documents from multiple entities. A query answer can be generated for the entity documents with an iterative question answer controller. The query answer can be converted into a dimensional matrix. Semantic data regarding the query answer can be visualized from the dimensional matrix with a visualization component of the iterative question answer controller to perform downstream tasks to resolve issues with the multiple entities.

In an embodiment, entity data 106 and user queries 107 can be processed by an iterative question answer (QA) controller 301 to generate query answers 117. The iterative QA controller 301 can process multiple queries regarding the monitored entities 101. The iterative QA controller 301 can iteratively process elements of the datasets by generating multiple queries for the elements of the datasets. For example, a query generated for monitored entity 101 can be iterated for similar entities to monitored entity 101.

Entity data 106 can include a dataset related to monitored entities 101 such as, companies of interest, data of trajectories for autonomous vehicle, etc. The dataset can be organized as a set of folders. Each folder represents a single entity. Each folder can include a number of files concerning the entity – these can include: text files such as entity summaries, structured data using a data format such as extensible markup language (xml) or javascript object notation (json), or image files such as tables, traffic scenes, etc. from a financial document. The user queries 107 can include queries posed by decision making entity 105 regarding the monitored entities 101.

In block 510, the decision making entity 105 can be prompted with an interface of the Iterative QA controller 301 with which to enter English language queries to be posed over multiple entities. The decision making entity 105 can select the type of the expected output for the answer from a drop down list including at least the selections: Boolean : Questions that expect a True or False reply – such as “is this company listed?”, and Numeric: Questions that expect a Scalar or numeric answer – such as “what was this company’s revenue for the year 2023?”.

In block 520, the Multi Agent Controller (MAC) 401 of the iterative QA controller 301 can generate a single answer for a set of documents representing a single company. To generate the single answer, the MAC 401 can perform the following operations as shown in blocks 521-527.

In block 521, the MAC 401 can match the types of the entity data to machine learning model services that are best suited to process them. In an embodiment, the MAC 401 can determine the file type or extension of the entity data and match them to machine learning model services that are pretrained for that file type or extension. For example, .txt files can be matched by the MAC 401 to the specialist text LLM 405.

In block 523, the MAC 401 can query the appropriate machine learning model service with instruction codes based on the input. In an embodiment, the instruction codes include textual description of how the machine learning model should execute actions to answer the user queries 107. In an embodiment, the specialist text LLM 405 can be queried for text inputs. In an embodiment, the specialist image LLM 406 can be queries for image inputs. The machine learning model service can include services for LLMs – they can be run on the same machine as the application, on an internal internet network to maintain privacy or remotely in a publicly hosted LLM service such as OpenAI™.

In block 525, to query the appropriate machine learning model service based on the input, a requests balancer 403 can be utilized by the MAC 401. The requests balancer 403 can process requests from the MAC 401 and translates a high-level label from the requests such as “large_text_llm” or “image_llm” to an Internet Host address for an LLM service. The requests (e.g., messages including the users questions, some directions and the document in question ) can be sent to the appropriate machine learning model service for processing.

In block 527, to process the requests, the requests balancer 403 balances service loads for the machine learning model services. To balance the service loads, in block 528, the requests balancer 403 accepts all requests from the MAC on a single queue and implements a scheme to balance service loads on the target LLM services. This balancing occurs over all concurrent company queries from the MAC 401. So, as the analysis for one entity focuses on text documents, another entity might be processing image documents. The requests balancer 403 can keep a balance of the total types of request in the queue.

In an embodiment, the scheme can include heuristics that distributes the external requests. The requests balancer 403 can receive a long unsorted queue of requests. Based on the scheme, the requests balancer 403 can limit the number of requests sent to the target LLM services. For example, the scheme can include a heuristic that ensures that no more than N requests is sent to the specialist text LLM 405.

The MAC 401 compares the responses from each (document, model) pair and selects the response with the highest confidence score as the answer. The MAC 401 can include a request in the instruction code for the target LLM services to estimate its confidence scores per output.

In block 530, the query answer from user queries 107 can be converted into a dimensional matrix. In an embodiment, the dimensional matrix can have at least two dimensions. In another embodiment, additional processing of the data can be performed to fill in (e.g., impute) missing values with standard machine learning techniques (e.g., regression, k-Nearest neighbors imputation, etc.).

In block 540, semantic data regarding the query answer can be visualized with visualization component 305 by rendering the set of query documents to perform downstream tasks to resolve issues with the multiple entities. In an embodiment, the semantic data can include relations and trends between the numerical answers and their corresponding entities.

In an embodiment, to render the set of query documents, the visualization component 305 can generate axes by using ML “embedding” methods that map N dimensions to 2 (x,y) where N is the number of user queries selected to be represented. This produces plots where similar documents are grouped together depending on the answers to the selected queries.

In an embodiment, axes can be set directly according to the numerical outputs of the queries (for example, by choosing “year of company founding” on the x axis and “company profits in 2024”, which can both be user queries over a set of company documents, we can generate an original plot with no user interaction other that the posing of the original queries over the original documents. As such, the visualization component 305 can convert directly from raw input documents to plots that generate insights.

In an embodiment, the decision making entity 105 can recursively select subsets of the data by lasso or threshold to generate an insight output. Each time the decision making entity 105 selects a subset of the data, the selection parameters are added to a history view of the selection process. The decision making entity 105 can then navigate (e.g., back, forward) through this history view to investigate their prior selections.

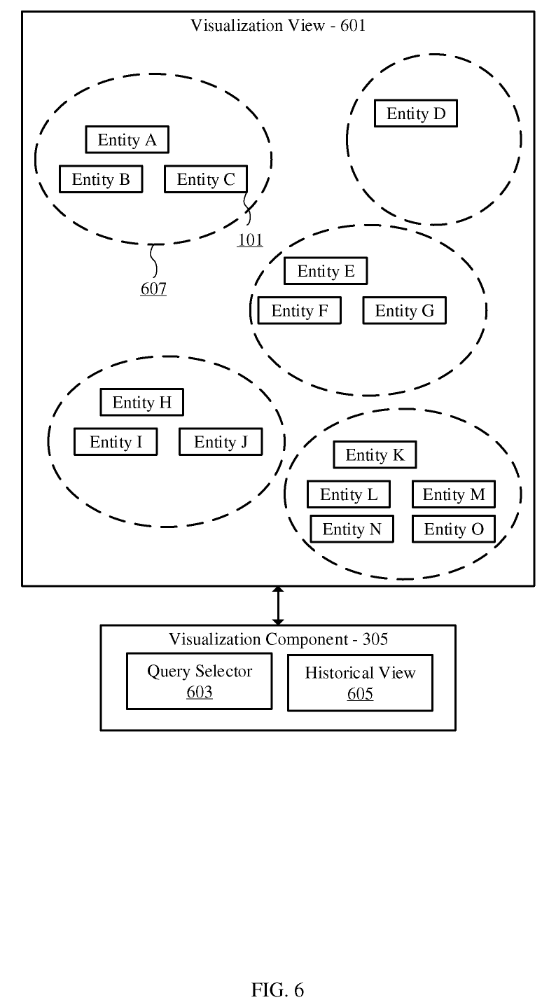

Referring now to FIG. 6, a block diagram that shows elements of a visualization component of a computer system for automated decision making for multiple datasets with machine learning, in accordance with an embodiment of the present invention.

The query answers 117 can be visualized for downstream tasks. The list of previously answered questions can also be shown through the historical view 605 and query selector 603. The 2-dimensional layout (positions) of the data including the query answers 117 can be determined by a layout algorithm such as uniform manifold approximation and projection (UMAP), which takes an N-dimensional representation of each entity and performs an optimization that produces a 2-dimensional set of positions that effectively tries to preserve spatial neighborhoods in the high N-dimensional space in the lower dimensional space. The N-dimensional space to reduce is selectable by the decision-making entity 105 and can update the dimensionality through the visualization component 305.

Based on the queries selected in the query selector, the visualizations can also be updated. The visualization view 601 can include clusters 607 of monitored entities 101 clustered based on determined similarity of properties of the monitored entities 101. This can uncover some clusters 607 that can reveal a new subset of the data the decision-making entity 105 was previously unaware of. For example, a decision-making entity 105 can look for entities with particular properties. The predictions of the target LLM services (e.g., specialist text LLM 405, specialist Image LLM 407) given the components of each compound for these properties, once visualized, would let the decision-making entity 105 see the possible tradeoffs and choose one meeting the needs of his use case.

The decision-making entity 105 can create a visualization view 601 based on the query answers 117 to user queries 107. They have assigned the answer for a user query 107 to the X axis and also assigned visual attributes to the answers to user queries 107. From this visualization view 601, it is easy to see that there are several clusters 607 in the data, which enables easier way to pick out the monitored entity 101 visually with the desired properties.

For network monitoring, the clusters can represent normal metric data and abnormal data. The entities can represent the metric data from a network system. For example, cluster for entity D can be identified as a normal request from a user within a second. Cluster for entities K,L,M,N,O can represent an abnormal request from a user within a second. As such, the cluster for entities K,L,M,N,O can be identified and corrective action 311 can be generated for issues resulting from such cluster such as blocking IP packets from the IP corresponding to the cluster.

For vehicle control, the clusters can represent driving behaviors and the entities can represent entities within a traffic scene. Based on user queries 107, the visualization view 601 can be updated. The visualization view 601 can then be utilized by the decision-making entity 105 to control the autonomous vehicle 104. In another embodiment, the visualization view 601 can be utilized by to generate trajectories to navigate and control the autonomous vehicle 104 within the traffic scene.

The decision making entity 105 can interact with the visualization component 305 with peripheral devices 114. The visualization view 601 can be interacted with in at least two ways: the user can pan and zoom around the displayed companies with a mouse or touch. The visualization component 305 can provide the decision making entity 105 the tools to recursively select subsets of the data by lasso or threshold and filter the data to a reduced set. The filtering process is recorded in the historical view 605 and can be navigated (like a browser history). The visualization component 305 can provide the decision making entity 105 tools to assign visual attributes such as size or color to the query answers 117 of particular user queries 107 through the query selector 603.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
prompting a decision making entity with an interface to generate user queries for entity documents from multiple entities;
generating a query answer for user queries for the entity documents with an iterative question answer controller;
converting the query answer into a dimensional matrix; and
visualizing semantic data regarding the query answer from the dimensional matrix with a visualization component of the iterative question answer controller to perform downstream tasks to resolve issues with the multiple entities.

2. The method of claim 1, wherein generating the query answer further comprises matching a type of entity data to machine learning model services that suited to process them.

3. The method of claim 2, wherein generating the query answer further comprises querying the machine learning model services with an instruction code based on the type of entity data.

4. The method of claim 3, wherein generating the query answer further comprises translating high-level labels from requests sent to query the machine learning model services with the instruction code.

5. The method of claim 4, wherein generating the query answer further comprises balancing service loads for the machine learning model services.

6. The method of claim 5, wherein generating the query answer further comprises accepting the requests on a single queue and implementing a scheme.

7. The method of claim 1, wherein the downstream tasks further comprises controlling an autonomous vehicle to avoid collisions within a traffic scene based on the query answer through automated decision making.

8. A system, comprising:
a memory device; and
one or more processor devices operatively coupled with the memory device to perform operations including:
prompting a decision making entity with an interface to generate user queries for entity documents from multiple entities;
generating a query answer for user queries for the entity documents with an iterative question answer controller;
converting the query answer into a dimensional matrix; and
visualizing semantic data regarding the query answer from the dimensional matrix with a visualization component of the iterative question answer controller to perform downstream tasks to resolve issues with the multiple entities.

9. The system of claim 8, wherein generating the query answer further comprises matching a type of entity data to machine learning model services that suited to process them.

10. The system of claim 9, wherein generating the query answer further comprises querying the machine learning model services with an instruction code based on the type of entity data.

11. The system of claim 10, wherein generating the query answer further comprises translating high-level labels from requests sent to query the machine learning model services with the instruction code.

12. The system of claim 11, wherein generating the query answer further comprises balancing service loads for the machine learning model services.

13. The system of claim 12, wherein generating the query answer further comprises accepting the requests on a single queue and implementing a scheme.

14. The system of claim 8, wherein the downstream tasks further comprises controlling an autonomous vehicle to avoid collisions within a traffic scene based on the query answer through automated decision making.

15. A non-transitory computer program product comprising a computer-readable storage medium including a program code, wherein the program code when executed on a computer causes the computer to perform operations including:
prompting a decision making entity with an interface to generate user queries for entity documents from multiple entities;
generating a query answer for user queries for the entity documents with an iterative question answer controller;
converting the query answer into a dimensional matrix; and
visualizing semantic data regarding the query answer from the dimensional matrix with a visualization component of the iterative question answer controller to perform downstream tasks to resolve issues with the multiple entities.

16. The non-transitory computer program product of claim 15, wherein generating the query answer further comprises matching a type of entity data to machine learning model services that suited to process them.

17. The non-transitory computer program product of claim 16, wherein generating the query answer further comprises querying the machine learning model services with an instruction code based on the type of entity data.

18. The non-transitory computer program product of claim 17, wherein generating the query answer further comprises translating high-level labels from requests sent to query the machine learning model services with the instruction code.

19. The non-transitory computer program product of claim 18, wherein generating the query answer further comprises balancing service loads for the machine learning model services.

20. The non-transitory computer program product of claim 19, wherein generating the query answer further comprises accepting the requests on a single queue and implementing a scheme.
